(19) United States
(12) Patent Application Publication
(10) Pub. No.: US 2026/0269434 A1
(43) Pub. Date: Sep. 10, 2026

(54) METHOD FOR PRODUCING A PRISMATIC BATTERY CELL, PRISMATIC BATTERY CELL AND MOTOR VEHICLE

(71) Applicant: PowerCo SE, Salzgitter (DE)

(72) Inventors: Björn LÖHR, Werlaburgdorf (DE); Marvin CZECH, Braunschweig (DE); Marius EBBIGHAUSEN, Braunschweig (DE); Natascha VON ASPERN, Braunschweig (DE); Lukas KWOCZEK, Salzgitter (DE)

(21) Appl. No.: 19/675,916

(22) Filed: May 13, 2026

Related U.S. Application Data
(63) Continuation of application No. PCT/EP2024/081468, filed on Nov. 7, 2024.

(30) Foreign Application Priority Data
Nov. 13, 2023 (DE) 102023211199.3

(51) Int. Cl. H01M 50/536; B23K 26/18; B23K 26/24; H01M 50/15; H01M 50/166; H01M 50/209; H01M 50/249

(52) U.S. Cl. CPC H01M 50/536; B23K 26/18; B23K 26/24; H01M 50/15; H01M 50/166; H01M 50/209; H01M 50/249

(57) ABSTRACT

A method for producing a prismatic battery cell includes providing an electrode stack with first and second electrodes stacked over one another. Arresters of the first electrodes protrude beyond an end face of the electrode stack in longitudinal direction. Arresters of the first electrodes are compacted and welded together, in particular by ultrasonic welding. The compacted arresters are disposed on a flat lateral surface of a contact element of a cell cover of a cell housing. The contact element forms a cell terminal. The compacted arresters are welded to the contact element, in particular by laser welding. The cell cover is disposed or pushed on the electrode stack such that the cell cover, or the lateral surface, is parallel to the end face. A prismatic battery cell and a motor vehicle including such a battery cell, are also provided.

### CROSS-REFERENCE TO RELATED APPLICATION

This application is a continuation, under 35 U.S.C. § 120, of copending International Patent Application PCT/EP2024/081468, filed Nov. 7, 2024, which designated the United States; this application also claims the priority, under 35 U.S.C. § 119, of German Patent Application DE 10 2023 211 199.3, filed Nov. 13, 2023; the prior applications are herewith incorporated by reference in their entirety.

### FIELD AND BACKGROUND OF THE INVENTION

The invention relates to a method for producing a prismatic battery cell, in which arresters of first electrodes thereof are compacted and welded to a contact sheet. The invention additionally relates to a prismatic battery cell produced according to such a method.

An electrically powered motor vehicle typically has a traction battery (high-voltage, HV, battery), which supplies energy to an electric motor for powering the motor vehicle. As such, an electrically powered motor vehicle is understood to mean in particular an electric vehicle, which only stores the energy needed for propulsion in the traction battery (BEV, battery electric vehicle), an electric vehicle with a range extender (REEV, range extended electric vehicle), a hybrid electric vehicle (HEV), a plug-in hybrid electric vehicle (PHEV) and/or a fuel cell electric vehicle (FCEV), which buffers the electrical energy generated by a fuel cell in the traction battery.

Such a traction battery typically includes multiple battery cells, in particular lithium-ion battery cells, which are electrically connected in series with one another and/or are connected in parallel with one another.

As such, the battery cells are divided into different kinds or types depending on their configuration. For example, a pouch cell (coffee bag cell) has a film, in particular an aluminum composite film, as a sleeve in which the electrodes of the battery cell are enclosed. In contrast, a cylindrical battery cell includes a comparatively rigid housing, in particular made of a metal sheet, wherein the housing substantially has a circular-cylindrical shape. Furthermore, so-called prismatic battery cells are known, the housing of which is also formed to be comparatively rigid, in particular made of a metal sheet, and which are substantially cuboidal.

A battery cell is known from German Patent Application DE 10 2021 114 887 A1. It includes a housing and a plurality of electrodes disposed therein with at least one anode and at least one cathode. The housing has a casing part with at least one open end face, wherein the end face is closed by a multi-layer cover element. A first layer of an electrically conductive material is connected to the anodes or to the cathodes.

German Patent Application DE 10 2019 102 032 A1, corresponding to U.S. Publication No. 2022/0089038 A1, relates to an energy storage cell with multiple electrodes of a first polarity and multiple electrodes of a second polarity, wherein the electrodes are disposed in an electrode stack. The electrodes of the first polarity each have a first arrester lug projecting from the electrode stack on a first side of the electrode stack, and the electrodes of the second polarity each have a second arrester lug projecting from the electrode stack on a second side of the electrode stack opposite the first one. The electrode stack is disposed in a housing electrically conductively connected to the first arrester lugs.

German Patent Application DE 10 2021 108 104 A1, corresponding to U.S. Pat. No. 12,424,608 B2, describes a method for producing a component, wherein the component has a plurality of cell films stacked on top of one another and at least one contact sheet. In an attachment portion, the cell films form a film stack, and the film stack is connected to the contact sheet by at least one welded seam.

### SUMMARY OF THE INVENTION

It is accordingly an object of the invention to provide a particularly suitable method for producing a prismatic battery cell, a prismatic battery cell and an electrically powered motor vehicle having such a battery cell, which overcome the hereinafore-mentioned disadvantages of the heretofore-known methods and devices of this general type.

With the foregoing and other objects in view there is provided, in accordance with the invention, a method for producing a prismatic battery cell, wherein an electrode stack is provided with first electrodes and second electrodes which are stacked one over the other, arresters of the first electrodes protrude beyond an end face of the electrode assembly in the longitudinal direction, arresters of the first electrodes are compacted and welded together, in particular by ultrasonic welding, the compacted arresters are disposed on a flat lateral surface of a contact element of a cell cover of a cell housing, the contact element forming a cell terminal, and the compacted arresters are welded to the contact element, in particular by laser welding, and the cell cover is disposed on the electrode stack, in particular the cell cover is pushed thereon, such that the cell cover, in particular the lateral surface, is parallel to the end face.

Advantageous embodiments and further developments are the subject matter of the dependent claims. As such, the statements relating to the method analogously also apply to the battery cell, and vice versa.

The method serves for producing a prismatic battery cell. Advantageously, the latter is configured as a lithium-ion battery cell. Preferably, the battery cell is provided and configured for a traction battery of an electrically powered motor vehicle.

First, an electrode stack is provided, having first electrodes and second electrodes stacked one over the other in a direction referred to here and hereinafter as a stacking direction or vertical stacking direction. This means, the electrode stack is formed from a number of first electrodes and from a number of second electrodes, wherein the electrodes are stacked one over the other in the stacking direction. Advantageously, the first and second electrodes are disposed alternately, wherein a separator is disposed between each first and second electrodes adjacent to one another.

As an example, each of the first electrodes is configured as an anode and each of the second electrodes is configured as a cathode.

Suitably, each electrode is configured to be leaf-shaped. As such, the respective electrode is formed from a film-like substrate, in particular a metal foil. The respective substrate includes a (first) portion coated with an active material, and an arrester as a second portion, in particular molded to the portion. The arrester is also referred to as a lug. Advantageously, the coated portion of the substrate of each of the electrodes has a rectangular base area. Preferably, the base area is not square, in other words, the rectangular base area has different side lengths. In the electrode stack, the first portions of the electrodes each span a surface perpendicular to the stacking direction. Advantageously, the arrester does not extend across the entire length of the corresponding side.

The arrester preferably protrudes beyond the shorter side of the rectangular first portion of the respective substrate.

Suitably, in the electrode stack, the arresters of the first electrodes extend in a direction referred to as a longitudinal direction, which is perpendicular to the stacking direction, away from the first portion of the respective substrate, and the arresters of the second electrodes extend counter to the longitudinal direction away from the first portion of the respective substrate. Thus, the arresters of the first electrodes are stacked one over the other in the stacking direction, and the arresters of the second electrodes are stacked one over the other in the stacking direction. As such, the arresters of the first electrodes are disposed on the side of the electrode stack referred to as the first end face, and the arresters of the second electrodes are disposed on the second end face of the electrode stack opposite the first end face, i.e., oriented in parallel thereto and oriented perpendicularly to the stacking.

In summary, the arresters of the first electrodes protrude beyond the first end face of the electrode stack in the longitudinal direction, and the arresters of the second electrodes protrude beyond the second end face opposite the first end face counter to the longitudinal direction. As such, the longitudinal direction is the direction along one of the, in particular longer, edges of a substrate, from the second to the first end face.

According to the method, the arresters of the first electrodes are compacted and welded together. As such, the compacting and welding may be performed successively in time. More preferably, the arresters of the first electrodes are welded together by ultrasonic welding. The compacting and welding together are then advantageously accomplished jointly in the course of the ultrasonic welding. Preferably, the arresters are acted on directly by the ultrasonic tools. In other words, a protective element, in particular a protective film or protective sheet, which is introduced between the respective ultrasonic tool and the arresters and is welded to the arrester is not used.

Advantageously, the compacted arresters of the first electrodes are then trimmed, i.e., cut to size, in particular cut off, so that the free ends of the arresters are aligned with one another in the stacking direction.

Subsequently, the arresters of the first electrodes together (and advantageously cut to size) are welded to a contact element of a cell cover of a cell housing which is electrically conductive. In particular, the arresters are laser-welded to the contact sheet. To this end, the compacted region of the arresters is first disposed on a flat lateral surface of the contact element. In particular, the compacted region of the arresters rests, preferably directly, i.e., immediately, on the flat lateral surface. Subsequently, the welding of the arresters to this lateral surface is accomplished in the region disposed thereon. More preferably, when laser-welding the contact element and the arresters that region of the arresters is welded which is also compacted and/or welded by ultrasonic welding, in other words, when laser-welding, the laser acts on the ultrasonically welded and/or compacted region of the arresters. As the distance of the arresters with respect to one another in the compacted/ultrasonically welded region is comparatively small, this enables particularly reliable joining of the arresters to the contact element.

As such, the contact element forms a (cell) terminal. This means that the contact element is electrically connected to the arresters of the first electrodes, wherein the contact element is electrically and/or mechanically contactable from outside the cell when the battery cell is assembled, in particular to connect the contact element to a conductor rail of a battery circuit. Advantageously, the contact element is configured to be integral (monolithic), in particular as a metal part. The contact element projects through the cell cover. As such, the flat lateral surface to which the arresters are welded forms the battery cell inner side of the contact element. Thus, the welding of the arresters is accomplished at a cell inner side of the contact element. For example, the contact element includes a plate-shaped portion forming the flat lateral surface, wherein an, advantageously pin-shaped, projection protrudes beyond the latter and projects through the cell cover.

In particular, the contact element is configured to be integral, i.e., monolithic. Furthermore, the cell cover is advantageously configured as an assembly, meaning that it is pre-assembled. Accordingly, the components of the cover do not need to be joined after having been welded on.

Subsequently, the cell cover is disposed on the electrode stack such that the cell cover, in particular the flat lateral surface of its contact element to which the arresters are welded, is parallel to the first end face. To this end, the arresters of the first electrodes, in particular in their non-compacted region, are bent (turned over) such that, after bending, the cell cover covers the end face of the electrode stack relative to the longitudinal direction. In summary, the cell cover is collapsed. Thus, the cell cover is more preferably disposed on the first end face of the electrode stack.

The bending (turning over) is advantageously accomplished by two blades extending in the transverse direction and spaced apart from one another in the longitudinal direction, wherein one of the blades presses against the arresters from above and the other blade from below relative to the vertical stacking direction. In summary, the flat lateral surface forming the inner side of the contact element, i.e., that side of the contact element to which the contact sheet is welded, is shifted towards the first end face due to the bending.

Preferably, the cell cover, advantageously after aligning the cell cover in parallel to the first end faces, is pushed onto the electrode stack, in particular counter to the longitudinal direction.

In summary, a method for producing a battery cell is advantageously implemented, the arresters of which battery cell are disposed on opposite end faces of the electrode stack.

For example, the cell cover includes an, in particular electrically insulating, stopper frame and an outer wall, wherein, when assembled, the outer wall is disposed on the cell outer side and the stopper frame is disposed on the side of the outer wall facing the cell interior of the battery cell. Advantageously, the contact element forming the terminal projects through both the stopper frame and the outer wall.

Preferably, the stopper frame of the cell cover has a projection extending perpendicularly to, in particular protruding beyond, the lateral surface of the contact element. Preferably, when pushing the cell cover onto the electrode stack, the projection is pressed into the electrode stack. For example, one such projection each is provided on the stopper frame in the transverse direction. Thus, the projections are pressed, i.e., penetrate, into the electrode stack on both side of the arresters. As such, a maximum penetration depth of the projection into the electrode stack preferably is 1 mm or less. This means, the electrode stack is at least slightly deformed in the process. This way, the cell cover is retained on the electrode stack.

Advantageously, the height of the projection, i.e., its extension in a direction perpendicular to the lateral surface of the contact element, is greater than the maximum penetration depth. For example, the height of the projection is between 2.5 mm and 5 mm. This way, when assembled, a space is formed (next to the projection) between the electrode stack and the cell cover in which the, in particular bent, arresters can be received. Thus, the projections additionally form a kind of spacer.

According to an advantageous embodiment, for forming the electrode stack (prior to being provided, i.e., prior to the arresters of the first electrodes thereof being welded together), two individual stacks (individual electrode stacks) separate from one another are stacked one over the other. As such, each of the individual stacks includes first electrodes and second electrodes stacked one over the other and advantageously separators disposed therebetween. As such, first und second electrodes are fixed relative to one another, for example by an adhesive tape (fixing tape). For example, each of the individual stacks includes between 50 and 200, in particular 100, first and between 50 and 200, in particular 100, second electrodes.

This means that the two individual stacks are stacked one over the other to form the electrode stack such that the arresters of the first electrodes and those of the second electrodes are each disposed one over the other in the stacking direction. Subsequently, the arresters of the first electrodes are compacted and welded together.

Advantageously, a deviation in the positioning of the electrodes relative to one another when forming the electrode stack from individual stacks is smaller than when forming an (individual) electrode stack with a correspondingly greater number of electrodes.

As an alternative to forming the electrode stack by stacking the two individual stacks one over the other, it is produced by so-called butterfly welding. Here, the individual stacks are first disposed next to one other such that their end faces with the arresters of the first electrodes are opposite one another, i.e., facing one another, while the individual stacks are inclined towards one another. In particular, the arresters of the two individual stacks are then disposed adjacent to one another such that the uppermost arrester of the first individual stack, i.e., the arrester facing the second individual stack, is disposed on the uppermost arrester of the second individual stack, i.e., on the arrester facing the first individual stack. The arresters of the first electrodes are then welded together, advantageously by ultrasonic welding. Subsequently, one of the individual stacks is folded onto the other individual stack to form the electrode stack.

According to an advantageous embodiment, the upper arrester with respect to a vertical stacking direction and/or the lower arrester with respect to the vertical stacking direction is/are provided, in particular laminated, with an, in particular electrically insulating, protective film. Advantageously, in terms of timing, this is done after welding the arresters together and preferably after welding the arresters to the contact element, and advantageously, in terms of timing, prior to arranging the cell cover on the electrode stack so that the lateral surface is parallel to the first end face, i.e., in particular, in terms of timing, prior to bending the arresters for this purpose. This advantageously avoids damage to the arresters when assembling the battery cell, in particular when bending the arresters, or at least reduces a risk thereof. Furthermore, this avoids contact of the bent arresters with the edges of the second electrodes on the first end face.

Preferably, the respective protective film then projects beyond the arresters in a transverse direction oriented transversely to the longitudinal direction and to the stacking direction. In other words, the protective films protrude from the arresters laterally, i.e., along the short edge of the first portions of the substrates.

Preferably, for comparatively secure retention, the protective films are also partially, in particular at the end with respect to the longitudinal direction, fastened, in particular adhered, to the top of the electrode stack or to the bottom of the electrode stack.

As such, the top is understood to mean the upper side of the electrode stack with respect to the stacking direction, and the bottom is understood to mean the lower side of the electrode stack with respect to the stacking direction. Thus, the top and bottom are oriented perpendicularly to the stacking direction.

A welding strip is used in particular as the protective film.

According to a preferred embodiment of the method, advantageously prior to arranging the cell cover on the first end face by bending the arresters, i.e., prior to arranging the lateral surface on the electrode stack in parallel to the end face, the welded seam resulting from welding the contact sheet to the contact element is covered with a further protective film. To this end, the further protective film is adhered to the contact sheet, for example. It then covers at least the welded seam, for example also the region of the arresters and/or the contact element in the area of the welded seam. With the further protective film, damage to the arresters when arranging the cell cover due to welding residues, a sharp edge or a burr of the welded seam is avoided.

Advantageously, the cell cover and the electrode stack are fixed relative to one another by a fixing film. For example, to this end, the electrode stack and the cell cover are wrapped with the fixing film, in particular at the lateral surfaces of the stopper frame thereof oriented in parallel to the longitudinal direction, and adhered to the electrode stack and/or the cell cover, for example. Subsequently, the fixing film is advantageously joined to the cell cover, in particular the stopper frame thereof, for example by heat staking or welding. Suitably, the fixing film is electrically insulating.

According to an advantageous embodiment of the method, in the longitudinal direction, i.e., from the second end face towards the first end face of the electrode stack, a housing shell (housing frame, cell casing) is pushed over the electrode stack, in particular fixed to the cell cover by the fixing film, and/or over the stopper frame of the cell cover.

For example, the housing shell is formed from metal sheet, in particular from aluminum. In summary, the housing shell forms the lateral walls of the housing of the battery cell oriented in parallel to the longitudinal direction. Together with the cell cover, the housing shell forms a so-called cell cup. This means, the housing shell is configured in a hollow-cylindrical shape, wherein the cylinder has a rectangle as the base area.

According to a convenient embodiment, the cell cover, in particular the outer wall thereof, is disposed on the free-end side of the housing shell, in particular resting thereon. Advantageously, the stopper frame is then disposed in the space included by the housing shell. This means, in a direction perpendicular to the longitudinal direction, i.e., to the direction of extension of the housing shell, the outer wall is larger than the stopper frame and larger than the opening of the housing shell. Thus, the cell cover covers the housing shell relative to the longitudinal direction, in particular, the cell cover, when assembled, is aligned with the housing shell relative to the longitudinal direction. The free-end side of the housing shell is that side which is oriented perpendicularly to the longitudinal direction, i.e., to the direction of extension of the housing shell.

In summary, the cell cover closes the opening of the housing shell.

With the objects of the invention in view, there is furthermore provided a prismatic battery cell produced according to the method in one of the variations set forth above. Thus, the battery cell includes an electrode stack with advantageously alternating first second electrodes stacked one over the other. As such, the arresters of the first electrodes are disposed on a (first) end face of the electrode stack. The arresters are compacted and welded together, in particular welded together by ultrasonic welding. Additionally, the arresters are welded, in particular laser-welded, to the flat lateral surface of the contact element, in particular in the region welded by ultrasonic welding, wherein the contact element of one of the cell terminals forms the prismatic battery cell. Then, when the battery cell is assembled, the cell cover, in particular the flat lateral surface of the contact element thereof, is parallel to the first end face.

Preferably, the electrode stack is then in turn formed by two individual stacks stacked one over the other.

Preferably, the upper arrester with respect to the vertical stacking direction and/or the lower arrester with respect to the vertical stacking direction is/are provided with an, in particular electrically insulating, protective film.

Preferably, the electrode stack and the cell cover are fixed relative to one another by a fixing film.

Preferably, the welded seam resulting from welding the contact sheet to the contact element is covered, in particular masked, with a further protective film.

Preferably, a housing shell of a cell housing is pushed over the electrode stack (and, if present, over the stopper frame of the cell cover). Thus, when assembled, the electrode stack and/or the stopper frame of the cell cover are disposed in the housing interior, hence in the space formed by the housing shell. More preferably, the cell cover, in particular the outer wall thereof, is disposed on the free-end side of the housing shell, thus covering it in a direction parallel to a central axis of the housing shell.

Preferably, the stopper frame of the cell cover is pushed onto the electrode stack. In particular, the projection of the stopper frame then penetrates into the electrode stack.

With the objects of the invention in view, there is concomitantly provided an electrically powered motor vehicle having a prismatic battery cell configured in one of the variations set forth above and/or produced according to the method in one of the variations set forth above.

In particular, the motor vehicle includes a traction battery (HV battery), provided and configured to provide electrical energy for a traction drive. As such, the prismatic battery cell is part of the traction battery.

Other features which are considered as characteristic for the invention are set forth in the appended claims.

Although the invention is illustrated and described herein as embodied in a method for producing a prismatic battery cell, a prismatic battery cell and a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a flow diagram representing a sequence of a method for producing a battery cell;

FIG. 2 is a diagrammatic, perspective view of two individual stacks stacked one over the other to form an electrode stack;

FIG. 3 is a diagrammatic, perspective view of the electrode stack, wherein first arresters thereof are disposed on a first end face of the electrode stack, second arresters thereof are disposed on a second end face of the electrode stack, and the first arresters are welded to one other by ultrasonic welding on a free-end side;

FIG. 4 is a diagrammatic, perspective view of the electrode stack, wherein the first arresters are laser-welded to a contact element of a cell cover;

FIG. 5 is a diagrammatic, perspective view of the electrode stack, wherein the arresters are covered with a protective film and the laser-welded seam is covered with a further protective film;

FIG. 6 is a diagrammatic, perspective view of the electrode stack and the cell cover, wherein the cell cover is disposed in parallel to the first end face;

FIG. 7 is a diagrammatic and partial top view of the electrode stack, wherein the cell cover is pushed onto the electrode stack;

FIG. 8 is a diagrammatic, perspective view of the electrode stack, wherein the second arresters are joined to a contact sheet projecting through a stopper frame disposed on the second end face, and the electrode stack, and the stopper frame and the cell base are fixed relative to one another by a fixing film;

FIG. 9 is a diagrammatic, perspective view of the electrode stack fixed to the stopper frame and the cell cover by the fixing film, wherein a housing shell is pushed over the stopper frame and the electrode stack;

FIG. 10 is a diagrammatic, perspective view of a cell base joined to the contact sheet;

FIG. 11 is a diagrammatic, perspective view of the battery cell, wherein the cell cover and the cell base enclose the housing shell; and

FIG. 12 is a sectional view through the cell cover.

### DETAILED DESCRIPTION OF THE INVENTION

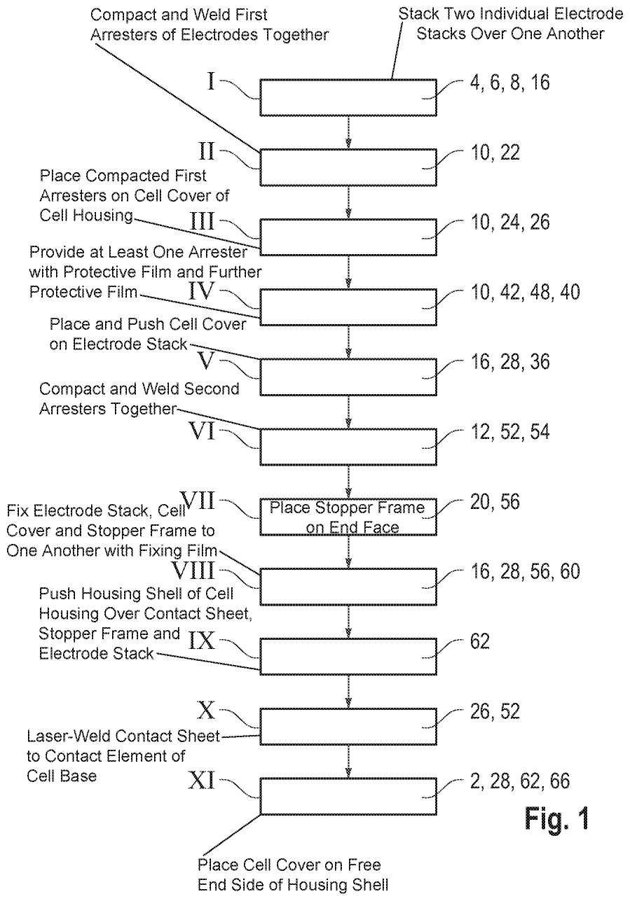

Referring now in detail to the figures of the drawings, in which corresponding parts and sizes are provided with the same reference symbols, and first, particularly, to FIG. 1 thereof, there is seen a flow diagram illustrating a method for producing a prismatic battery cell 2, in particular constructed as a lithium-ion battery cell.

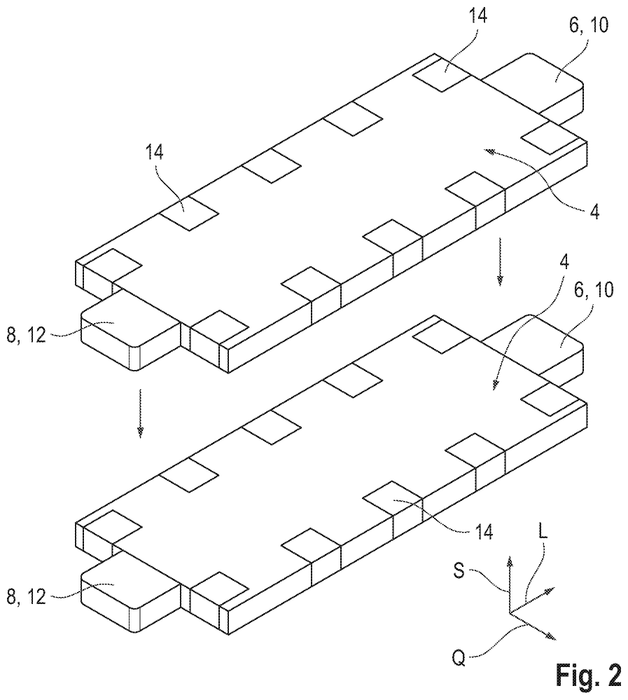

In the method, in a first step I, two individual stacks 4 (individual electrode stacks 4) separate from one another are stacked one over the other. In FIG. 2, this is represented by an arrow.

Each of the individual stacks 4 includes a plurality of first electrodes 6 and of second electrodes 8 alternately stacked one over the other in a stacking direction S, wherein one separator (not shown in detail) each is disposed between the first and second electrodes.

The first and second electrodes 6, 8 of each individual stack 4 are configured to be leaf-shaped. Each of them includes a film-like substrate with a rectangular portion coated with an active material and with an arrester. In the following, for the purpose of better differentiation, the arresters of the first electrodes 6 are referred to as first arresters 10 and the arresters of the second electrodes 8 are referred to as second arresters 12. The first and second arresters 10, 12 protrude beyond the shorter side of the rectangular coated portion. As such, for each of the individual stacks 4, the first arresters 10 are disposed one over the other and the second arresters 12 are disposed one over the other, wherein the first arresters 10 project to the first portion in a longitudinal direction L and the second arresters 12 project to the first portion of the respective substrate counter to the longitudinal direction L.

For each of the individual stacks 4, a fixing tape 14 is used through the use of which the electrodes 6, 8 of the respective individual stack 4 are fixed. As such, the fixing tape 14 is adhered to an upper side (top) of the respective individual stack 4 with respect to the stacking direction S and to a lower side (bottom) of the respective individual stack 4 with respect to the stacking direction S, thereby overlapping a side of the respective individual stack 4 oriented in parallel to the stacking direction S.

In the first step I, the two individual stacks 4 are disposed one over the other such that the arresters 10 of the first electrodes 6 of both individual stacks 4 are disposed one over the other in the stacking direction S. Accordingly, the arresters 12 of the second electrodes 8 of both individual stacks 4 are disposed one over the other in the stacking direction S.

By stacking the two individual stacks 4 one over the other, the first arresters 10 are disposed on a side of an electrode stack 16 being formed, which is referred to as a first end face 18. The second arresters 12 are disposed on a second end face 20 of the electrode stack 16 opposite the first end face 18, i.e., oriented in parallel thereto and perpendicularly to the stacking direction S. Thus, the longitudinal direction L is directed from the second end face 20 towards the first end face 18.

Advantageously, the two individual stacks 4 stacked one over the other are fixed relative to one another by a fixing tape 14.

In summary, stacking the two individual stacks 4 one over the other results in the electrode stack 16 being provided for further production of a battery cell 2, wherein the arresters 10 of the first electrodes 6 protrude beyond the first end face 18 of the electrode assembly 16 in the longitudinal direction L and the arresters 12 of the second electrodes 8 protrude beyond the second end face 20 counter the longitudinal direction L.

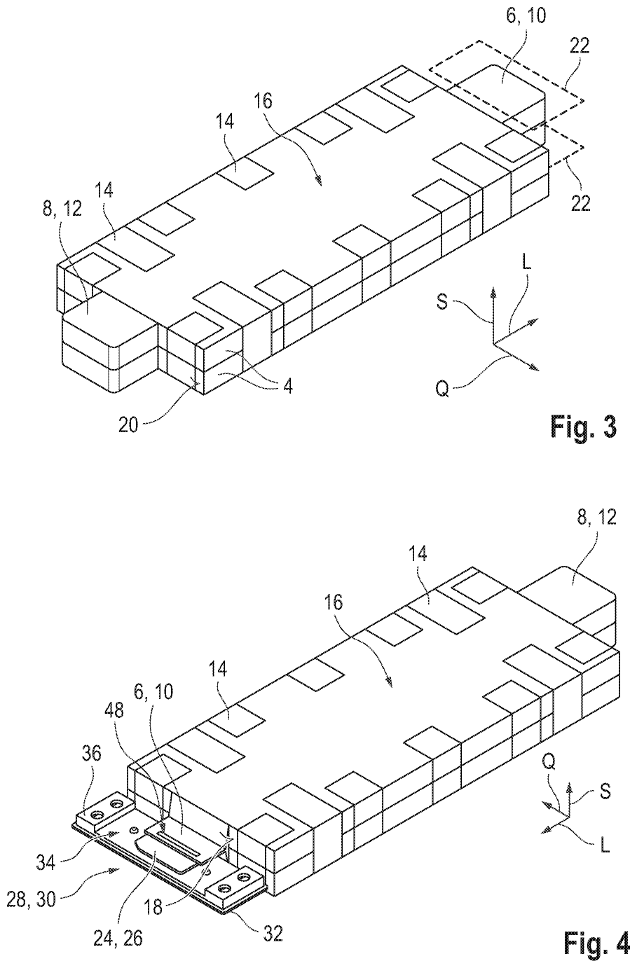

In a subsequent second step II, the arresters 10 of the first electrodes 6 are compacted and welded together. To this end, the first arresters 10 are welded together by ultrasonic welding using ultrasonic welding tools 22. This is shown in FIG. 3, in which the ultrasonic tools 22 are only schematically indicated by rectangles. During ultrasonic welding, both the compacting of the first arresters 10 and their joining are accomplished together. Advantageously, the first arresters 10 are then cut to size, in other words cut to length, i.e., trimmed, so that their free end, i.e., their ends facing away from the first end face 18, are aligned with one another.

In a subsequent third step III, the compacted first arresters 10 are disposed on a flat lateral surface 24 of a contact element 26 of a cell cover 28 of a cell housing 30. In particular, the compacted region of the first arresters 10 rests directly, i.e., immediately, on the flat lateral surface 24. Subsequently, the first arresters 10 compacted with one another are welded to the lateral surface 24, in particular by laser welding, cf. FIG. 4. To this end, the ultrasonically welded region of the first arresters 10 is acted on with a laser, so that the first arresters 10 are laser-welded to the contact element 26.

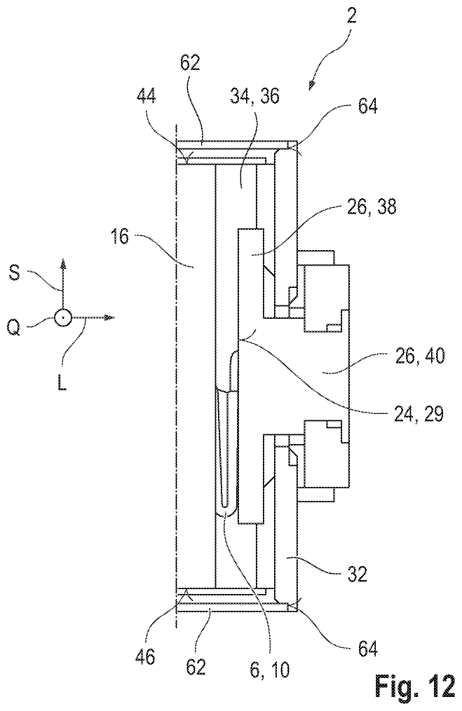

The layout of the cell cover 28 can be seen comparatively well in particular in FIGS. 4 to 6 and in the sectional diagram of FIG. 12. The cell cover 28 includes an advantageously flat (cell) outer wall 32. On the (inner) side thereof facing the electrode stack 16, i.e., on the side facing the cell interior of the battery cell 2, an, in particularly electrically insulating, stopper frame 34 is disposed. Preferably, the stopper frame 34 of the cell cover 28 has at least one projection 36 which extends cell inward perpendicularly to the lateral surface 24 of the contact element 26, i.e., when the battery cell 2 is assembled, the projection 36 extends counter to the longitudinal direction L. According to the embodiment shown here, the stopper frame 34 has two such projections 36, each of which is disposed at the end of the stopper frame 34 spaced apart from one another in the transverse direction Q.

The contact element 26 projects through both the stopper frame 34 and the outer wall 32, so that it is both electrically connected to the first arresters 10 on the cell inner side, and electrically and mechanically contactable on the cell outer side. The contact element 26 thus forms a terminal of the battery cell 2. The contact element 26 is configured to be integral (monolithic), in particular as a metal part. The contact element 26 includes a plate-shaped portion 38, the side of which facing the electrode stack 16 forms the flat lateral surface 24. A pin-shaped projection 40 is molded to the plate-shaped portion 38 and protrudes beyond it and projects through the cell cover 28.

Furthermore, the cell cover 28 is configured as an assembly, meaning that it is pre-assembled.

In a subsequent fourth step IV, the upper first arrester 10 with respect to a vertical stacking direction S and/or the lower one with respect to the vertical stacking direction S is/are provided with an electrically insulating protective film 42.

Optionally, the protective film 42 then projects beyond the first arresters 10 in a transverse direction Q oriented transversely to the longitudinal direction L and to the stacking direction S. This means that the respective protective film 42 projects laterally beyond the arresters 10. For comparatively secure retention, the protective films 42 are also partially, in particular at the end with respect to the longitudinal direction, fastened, in particular adhered, to the top 44 of the electrode stack or to the bottom 46 of the electrode stack 16. In other words, at the top 44 or at the bottom 46 of the electrode stack 4, the protective film 42 respectively extends beyond the area of the edge of the electrode stack 16 at which the respective arrester 10 is disposed.

As such, the top 44 is understood to mean the upper side of the electrode stack 16 with respect to the stacking direction S, and the bottom 46 is understood to mean the lower side of the electrode stack 16 with respect to the stacking direction S. The top 44 and the bottom 46 are oriented perpendicularly to the stacking direction S.

A welding strip is used in particular as the protective film 42.

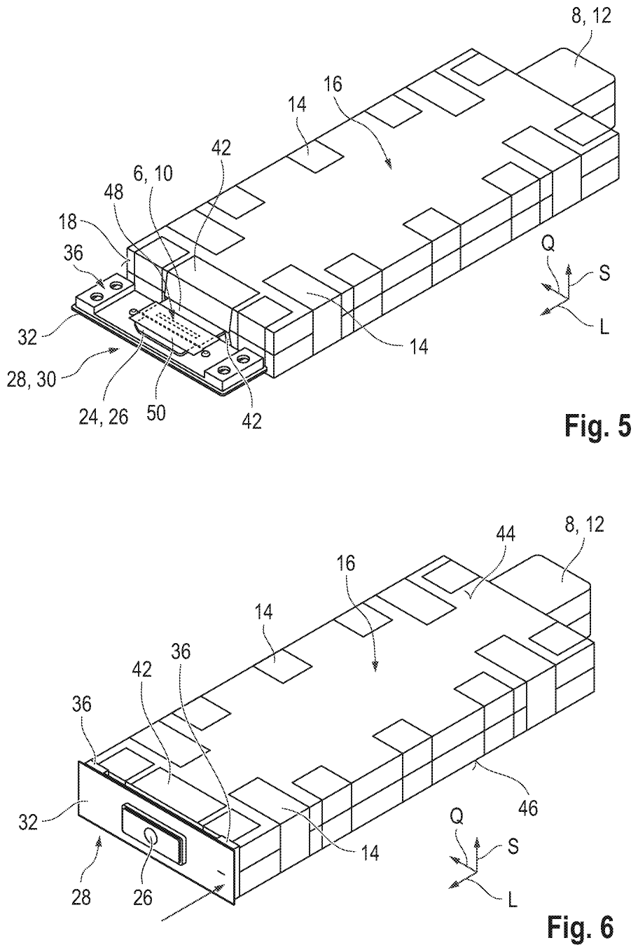

The attached protective films 42 can be seen in FIG. 5, for example.

Furthermore, in the fourth step IV, the (laser-) welded seam 48 resulting from laser-welding the first arresters 10 to the contact element 26 is covered with a further protective film 50, cf. also FIG. 5. As such, the further protective film 50 completely covers the welded seam 48. This avoids damage to the first arresters 10, in particular due to welding residues or due to the welded seam 48 itself. Advantageously, for comparatively secure retention, the region of the lateral surface 24 not covered by the first arresters 10 is additionally covered by the further protective film 50 and the latter is adhered in this region.

In a subsequent fifth step V, the cell cover 28 is disposed on the electrode stack 16 such that the cell cover 28 is in particular the lateral surface 24 and/or the outer wall 32 parallel to the first end face 18. To this end, the first arresters 10 are bent in the region in which they are not welded to the contact element 26. Here, the free end of the first arresters 10 is thus shifted towards the first end face 18.

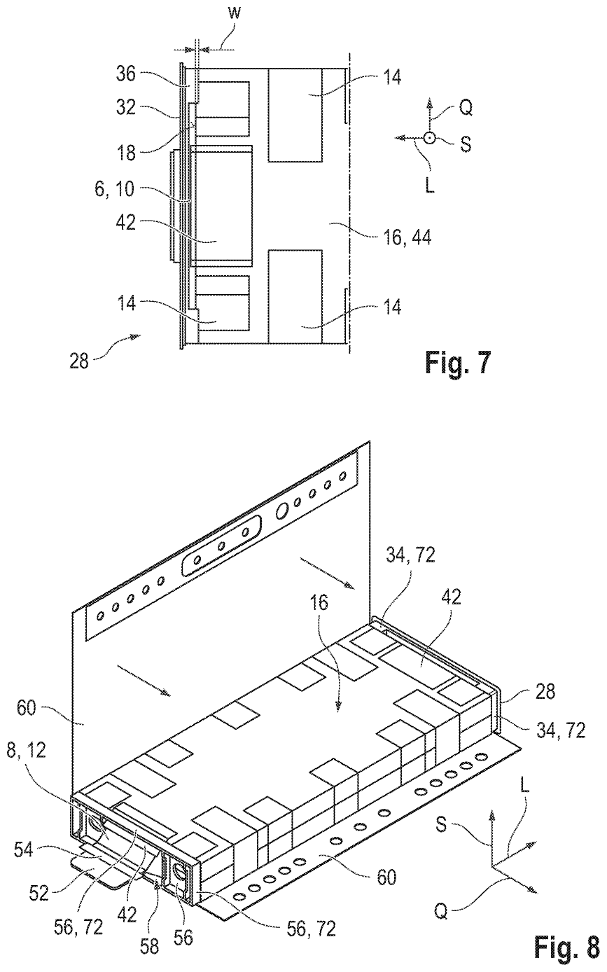

Subsequently, in the fifth step V, the cell cover 28 is pushed onto the electrode stack 16. As such, the projections 36 are pressed into the electrode stack 16, which is represented in FIG. 6 by an arrow. When assembled, the projections 36 are pressed, i.e., penetrate, into the electrode stack 16 with respect to the transverse direction Q on both sides of the first arresters 10. The cell cover 28 disposed on the first end face 18 is shown in FIGS. 6 and 7 in particular. As can be seen in FIG. 7 in particular, a maximum penetration depth w of the respective projection 36 into the electrode stack 16 is 1 mm or less. This means that the electrode stack 16 is at least slightly deformed, so that the cell cover 28 is retained on the electrode stack 16.

In a subsequent sixth step VI, the second arresters 12 are compacted and preferably welded together and advantageously subsequently trimmed. For example, to this end, the second arresters 12 are welded together by ultrasonic welding at least locally, for example in points or portions, so that they are pre-fixed to one another. Subsequently, the compacted second arresters 12 are introduced between a contact sheet 52 and a sacrificial sheet 54 and welded thereto by ultrasonic welding. Optionally, the upper second arrester 10 with respect to the vertical stacking direction S and/or the lower one with respect to the vertical stacking direction S is/are provided with an, in particular electrically insulating, protective film 42.

In a subsequent seventh step VII, a further stopper frame 56 (second stopper frame 56) is disposed on the second end face 20. As such, the contact sheet 52 welded to the second arresters 12 is guided through a feed-through 58 of the second stopper frame 56 extending in the longitudinal direction L. In other words, the stopper frame 56 is pushed over the contact sheet 52 and the second arrester 12, so that the contact sheet 52 and the second arresters 12 project through the feed-through 58 of the second stopper frame 56. This is shown in FIG. 8.

For example, the second stopper frame 56 is pushed onto the second end face 18 in an analogous manner to the (first) stopper frame 34, so that its projections penetrate into the electrode stack 16 (not shown in detail).

In a subsequent eighth step VIII, the electrode stack 16, the cell cover 28 and the second stopper frame 56 are fixed to one another by an, in particular electrically insulating, fixing film 60. To this end, the fixing film 60 is wrapped around the electrode stack 16 and around the lateral faces 72 of the stopper frame 34 of the cell cover 28 oriented in parallel to the longitudinal direction L and around the lateral faces 72 of the second stopper frame 34 oriented in parallel to the longitudinal direction L, which is represented in FIG. 8 by arrows. For example, the fixing film 60 is fixed by an adhesive tape 52 after the wrapping process. Additionally, the fixing film 60 is welded or joined by heat staking to the stopper frame 34 and to the second stopper frame 56 on their lateral surfaces 72 oriented in parallel to the longitudinal direction L.

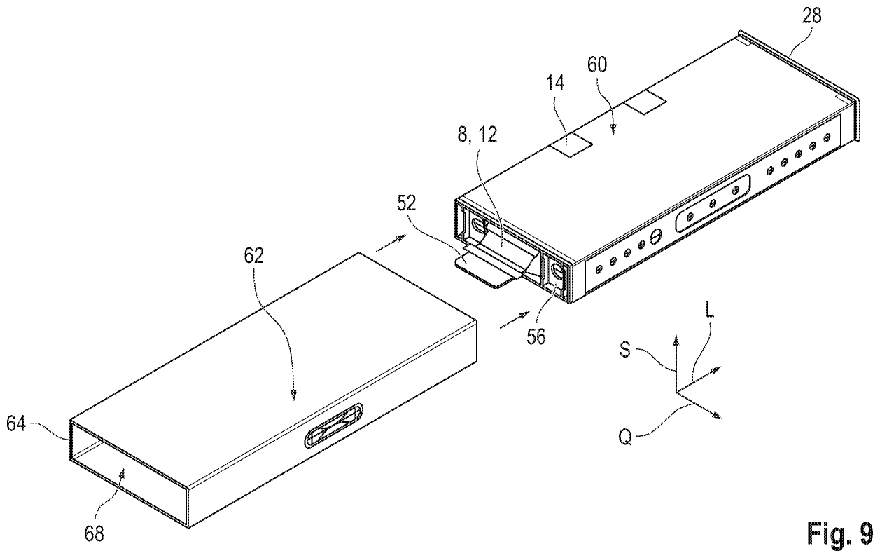

In a subsequent ninth step IX, a housing shell 62 of the cell housing 30 is pushed over the contact sheet 52, over the second stopper frame 56 and over the electrode stack 16, cf. also FIG. 9. As such, the housing shell 62 includes the cell interior, i.e., forms the lateral walls of the cell housing 30 oriented in parallel to the longitudinal direction L. Thus, the housing shell 62 is configured as a hollow prism (hollow cylinder with a rectangular base area).

The electrode stack 4 and the stopper frame 34 are disposed in the housing shell 62, i.e., received within the space formed by the housing shell 62.

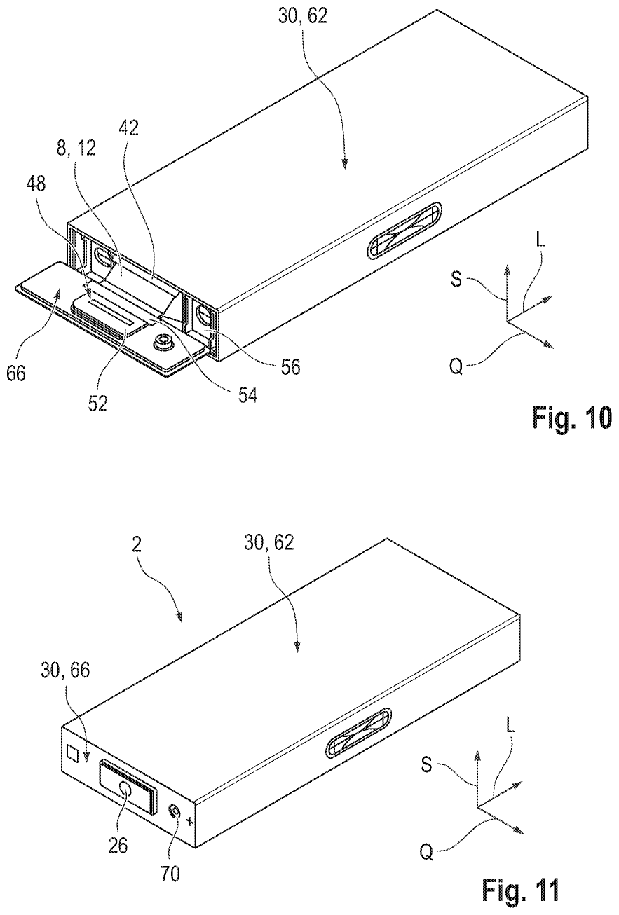

In a subsequent tenth step X, the contact sheet 52 is laser-welded to a contact element 26 of a cell base 66 of the cell housing 30, cf. also FIG. 10. As such, the contact element 26 forms a further terminal of the battery cell 2, i.e., the contact element 26 is electrically and/or mechanically contactable from outside of the battery cell 2, cf. FIG. 11. Thus, the welding of the contact sheet 52 is accomplished at a cell inner side of the contact element 26. In summary, the contact element 26 is connected to the second arresters 12 by the contact sheet 52 in an electrically conductive manner. Optionally, the (laser-) welded seam 48 resulting from welding the contact sheet 52 to the contact element 26 is covered with a further protective film 50.

In a subsequent eleventh step XI, the cell cover 28 is disposed on the free-end side 64 of the housing shell 62, cf. also FIG. 12. As a consequence, the cell cover 28 rests on the free-end side 64. The free-end side 64 is understood to mean the lateral surface of the housing shell 62 oriented perpendicularly to the longitudinal direction L, hence perpendicularly to the direction of extension or central axis of the housing shell 62.

Additionally, the cell base 66 is disposed on the other free-end side 64 of the housing shell 62, cf. also FIG. 11. To this end, the second arresters 12 are correspondingly bent, in particular turned over and/or folded in, in particular in their non-compacted region. As a result, the cell base 66 rests on this free-end side 64. Thus, the cell base 66 is disposed such that it covers the second stopper frame 56 and the second end face 20 of the electrode stack 16.

The cell cover 28 and the cell base 66 each close an opening 68 of the housing shell 62. Advantageously, the cell base 66 and the cell cover 28 are welded to the housing shell 62, in particular laser-welded in a fluid-tight manner, so that a cuboidal cell housing is formed.

Advantageously, the battery cell 2 is subsequently filled with an electrolyte through a filling opening 70 disposed in the cell base 66. For example, the filling opening 70 is then closed with a pin, in particular made of an elastomer. Subsequently, the filling opening 70 and the pin received therein are covered by a covering, in particular made of metal, and welded to an outer side of the cell base 66. Thus, the filling opening 70 is closed in a sealing manner.

In a manner not shown in more detail, an electrically powered motor vehicle, in particular the traction battery thereof, has a prismatic battery cell 2 produced according to the method set forth above.

The invention is not limited to the embodiment described above. Rather, other variations of the invention may also be derived therefrom by a person skilled in the art within the scope of the claims without departing from the subject matter of the invention. In particular, all of the individual features described in the context of the embodiment and/or in the claims may also be combined in other ways, without departing from the subject matter of the invention.

The following is a summary list of reference numerals and the corresponding structure used in the above description of the invention:
2 Battery cell
4 Individual stack
6 First electrode
8 Second electrode
10 Arrester of a first electrode
12 Arrester of a second electrode
14 Fixing tape
16 Electrode stack
18 First end face
20 Second end face
22 Ultrasonic tool
24 Lateral surface of the contact element
26 Contact element/terminal
28 Cell cover
30 Cell housing
32 Outer wall
34 (First) Stopper frame
36 Projection
38 Plate-shaped portion
40 Pin-shaped projection
42 Protective film
44 Top of the electrode stack
46 Bottom of the electrode stack
48 Welded seam
50 Further protective film
52 Contact sheet
54 Sacrificial sheet
56 (Second) Stopper frame
58 Feed-through
60 Fixing film
62 Housing shell
64 Free-end side
66 Cell bottom
68 Opening
70 Filling opening
72 Lateral surface
L Longitudinal direction
Q Transverse direction
S Vertical stacking direction/stacking direction
w Penetration depth
I Forming the electrode stack
II Welding the first arresters to one another by mean of ultrasonic welding
III Laser-welding the arresters welded together to the contact element
IV Attaching protective films
V Pushing the cell cover onto the electrode stack
VI Joining the second arresters with a contact sheet
VII Pushing the second stopper frame on
VIII Fixing the cell cover to the electrode stack
IX Pushing a housing shell on
X Welding the contact sheet to the contact element of the cell base
XI Closing the housing shell

1. A method for producing a prismatic battery cell, the method comprising:
providing an electrode stack with first electrodes and second electrodes stacked over one another, and arresters of the first electrodes protruding beyond an end face of the electrode stack in a longitudinal direction;
compacting and welding the arresters of the first electrodes together;
placing the compacted arresters on a flat lateral surface of a contact element of a cell cover of a cell housing, the contact element forming a cell terminal, and welding the compacted arresters to the contact element; and
placing the cell cover on the electrode stack, and orienting the cell cover or the lateral surface parallel to the end face.

2. The method according to claim 1, which further comprises compacting and welding the arresters of the first electrodes together by ultrasonic welding, welding the compacted arresters to the contact element by laser welding, and pushing the cell cover on the electrode stack.

3. The method according to claim 1, which further comprises forming the electrode stack by stacking two mutually-separate individual stacks over one another, each of the stacks having first electrodes and second electrodes stacked over one another and fixed relative to one another.

4. The method according to claim 1, which further comprises providing the arresters as an upper arrester relative to a vertical stacking direction and a lower arrester relative the vertical stacking direction, and providing at least one of the upper or lower arresters with an protective film.

5. The method according to claim 4, which further comprises providing the protective film as an electrically insulating protective film.

6. The method according to claim 1, which further comprises producing a welded seam when welding the arrester to the contact element, and covering the welded seam with a further protective film.

7. The method according to claim 1, which further comprises fixing the electrode stack and the cell cover to one another by using a fixing film.

8. The method according to claim 1, which further comprises providing a projection, the projection at least one of:
extending from a stopper frame of the cell cover perpendicularly to the lateral surface, or
being pressed into the electrode stack upon pushing the cell cover onto the electrode stack.

9. The method according to claim 1, which further comprises pushing a housing shell of a cell housing in the longitudinal direction over the electrode stack fixed to the cell cover.

10. The method according to claim 9, which further comprises fixing the electrode stack to the cell cover by using a fixing film.

11. The method according to claim 9, which further comprises placing the cell cover on a free-end side of the housing shell.

12. A prismatic battery cell, the prismatic battery cell being produced by the method according to claim 1.

13. A motor vehicle, comprising the battery cell according to claim 12.
